(19) United States
(12) Patent Application Publication
(10) Pub. No.: US 2012/0069049 A1
(43) Pub. Date: Mar. 22, 2012

(54) DIGITAL PATHOLOGY IMAGE MANIPULATION

(75) Inventors: Timothy Allen Howe, Pittsburgh, PA (US); Andrew Frederick Bruss, Easley, SC (US); Linda Marie O'Meara, Pittsburgh, PA (US); Michael Meissner, Pittsburgh, PA (US); Raghavan Venugopal, Pittsburgh, PA (US); Maura Ann Bidinost, Canonsburg, PA (US)

(73) Assignee: Omnyx, LLC, Pittsburgh, PA (US)

(21) Appl. No.: 13/233,575

(22) Filed: Sep. 15, 2011

Related U.S. Application Data
(60) Provisional application No. 61/383,576, filed on Sep. 16, 2010.

(51) Int. Cl. G09G 5/00

(52) U.S. Cl. 345/629

(57) ABSTRACT

Systems, methods, and products are described that provide for digital pathology image manipulation. One aspect provides for displaying one or more digital specimen images on a display device in one or more viewing windows arranged in one or more viewing configurations; and associating one or more images through one or more correlation processes comprising image co-registration, image locking, and image overlay processes. Other aspects and embodiments are also described herein.

### CROSS REFERENCE TO RELATED APPLICATION

This application claims the benefit of U.S. Provisional Patent Application Ser. No. 61/383,576, entitled “Digital Pathology Image Manipulation with Multiple Related Views,” filed on Sep. 16, 2010, the contents of which are incorporated by reference as if fully set forth herein.

### BACKGROUND

Access to digital specimen images has profoundly affected the field of pathology. Using digital image data relieves the pathologist from certain tasks associated with physical handling of glass specimen slides and manual manipulation of optical instruments. In addition, the use of digital images allows for automated processes for handling and manipulating images. Many organizations are attracted to digital pathology systems as a means to increase productivity and efficiency, ultimately leading to improved treatment decisions and patient care.

### BRIEF SUMMARY

In summary, one aspect provides a system comprising: one or more processors; a memory in operative connection with the one or more processors; wherein, responsive to execution of program instructions accessible to the one or more processors, the one or more processors are configured to: display one or more digital specimen images in one or more viewing windows arranged in one or more viewing configurations; and associate one or more images through one or more correlation processes comprising image co-registration, image locking, and image overlay processes.

Another aspect provides a method comprising: displaying one or more digital specimen images on a display device in one or more viewing windows arranged in one or more viewing configurations; and associating one or more images through one or more correlation processes comprising image co-registration, image locking, and image overlay processes.

A further aspect provides a computer program product comprising: a computer readable storage medium having computer readable program code embodied therewith, the computer readable program code comprising: computer readable program code configured to display one or more digital specimen images on a display device in one or more viewing windows arranged in one or more viewing configurations; and computer readable program code configured to associate one or more images through one or more correlation processes comprising image co-registration, image locking, and image overlay processes.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 provides an example digital pathology system.

FIG. 2 provides an example digital pathology workstation.

FIG. 3 provided an example digital image viewer.

FIG. 4 provides an example of multiple images displayed in a microscope viewing window.

FIG. 5 provides another example of multiple images displayed in a microscope viewing window.

FIG. 6 provides an example of image placement.

FIG. 7 provides an example grid used for image replacement or screen splitting.

FIG. 8 provides another example grid used for image replacement or screen splitting.

FIG. 9 provides an example process for image selection using a pointing device.

FIG. 10 provides an example process for image selection using a keyboard.

FIG. 11 provides an example process for image co-registration.

FIG. 12 provides an example process for locking images.

FIG. 13 illustrates an example circuitry of a computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail to avoid obfuscation.

Pathology involves the study and diagnosis of disease through the examination of specimens obtained from a patient with a medical concern. Conventional specimen examination procedures involve viewing glass specimen slides through an optical microscope. Advances in existing technology have produced digital image based pathology slides wherein traditional glass slides are replaced by digital specimen images. In general, digital specimen images are obtained by scanning glass slides with a digital scanner. After being created, digital specimen images are typically stored in a centralized database, and the images may be accessed through a computing device interface in communication with the database.

Pathologists may interact with digital specimen images at a workstation operating within a digital pathology system. The pathology workstation may be configured to utilize one or more processors and software routines to present selected images on a display device and provide image manipulation controlled by input/output devices. In addition, digital pathology computer systems may be integrated through data communications to one or more a patient or laboratory information systems and may support other associated functions, such as document handling, accounting, reporting, and the like. An exemplary digital pathology system utilizing digital specimen images has been disclosed in U.S. patent application Ser. No. 12/554,276, filed on Sep. 4, 2009, the contents of which are incorporated by reference as if fully set forth herein.

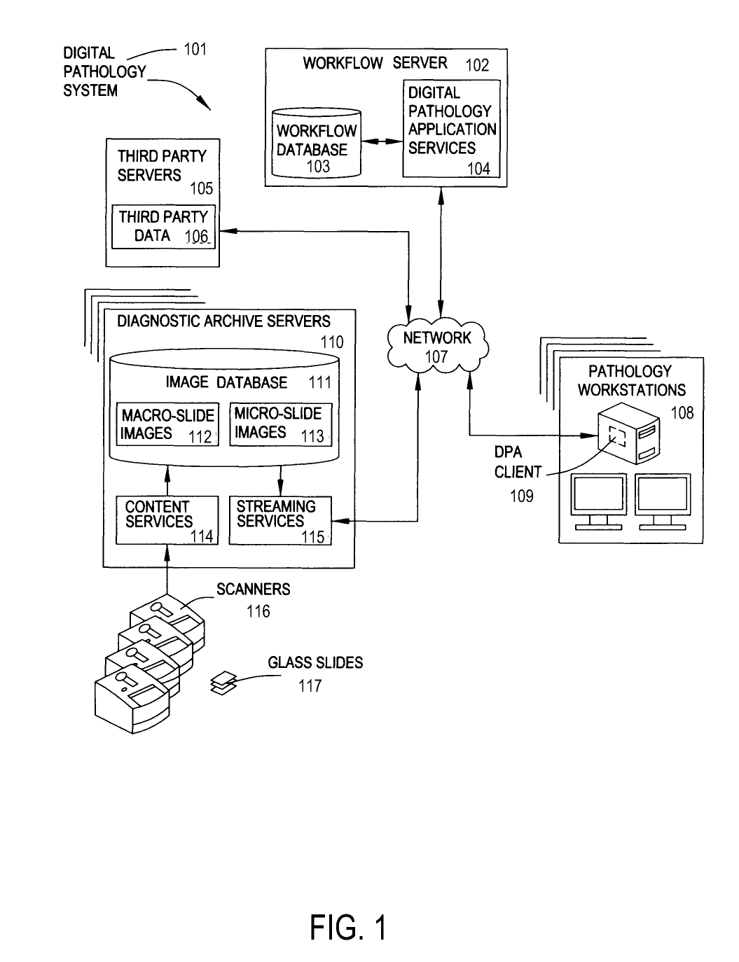

Referring to FIG. 1, therein is depicted an example digital pathology system according to an embodiment. A digital pathology system 101 is provided that comprises a workflow server 102, one or more third party servers 105, a diagnostic archive server 110, and pathology workstations 108 arranged in a network 107.

Digital specimen images may be generated by scanning prepared glass slides 117 using scanners 116 capable of transforming glass specimen slides into digital specimen images. In addition, the digital specimen images may be associated with slide and patient identifying information, as well as image identifying information, such as the image capture magnification, and the X, Y, or Z position on the slide. As shown in FIG. 1, the digital specimen images may be stored on a diagnostic archive server 110 in an image database 111. The database 111 may store the images along with a set of related fields, including data relating images to each other and the nature of the relationship, successive registered slices of the same sample representing depth or earlier or later stages of a subject disease or of healing.

Depending on the capabilities of scanners 116, macro-slide images 112 and/or micro-slide images 113 may be of any useful resolution. In one example, the scanning resolution of scanners 116 may be in the range of about 0.25 microns/pixel to about 5 microns/pixel (0.25 to 5×10−6 m/pixel). Each macro-slide image 112 is a single image that captures the entire slide at low magnification and is useful to determine where the sample resides on the glass slide 117. Each micro-slide image 113 contains an image of a portion only of the whole glass slide 117 that contains tissue. As such, multiple micro-slide images 113 may be associated with a single glass slide 117. For example, multiple micro-slide images 113 may be stitched together in a tiled fashion to represent a particular glass slide 117 in its entirety. Typically, macro-slide images 112 and micro-slide image 113 are captured using two different types of cameras within the scanner 116.

A content services module 114 may be utilized to manage the acquisition of digital specimen images, including macro-slide images 112 and micro-slide images 113. The outbound flow of digital specimen images to the network 107 may be managed through one or more streaming services 115. Digital specimen images may be accessed from an image database 111 through digital pathology workstations 108 running a digital pathology application (DPA) client 109. The DPA client 109 may provide navigation tools allowing a user, such as a pathologist, to view and manipulate digital slide images.

Third party data 106, such as data available through a general Laboratory Information System (LIS) or a specialized Anatomic Pathology Laboratory Information System (APLIS), may be integrated with the digital specimen images. As illustrated in FIG. 1, third party data 106 may be supplied through third party servers 105 operatively connected to the network 107. A workflow server 102 may be provided for hosting application services 104 that support one or more workstations 108 operatively connected through a network 107. The workflow server 102 may also include a workflow database 103 for storing data, including, but not limited to case data and information related to the digital pathology system, such as image catalog information for identifying the image server that is the source of the digital specimen images. One or more application services 104 may be operational on the workflow server 102. According to embodiments, application services 104 may include functions directed toward assigning cases, managing case information and access thereto, managing images stored on the diagnostic archive servers 110, providing reporting mechanisms, and facilitating data exchange between network 107 components.

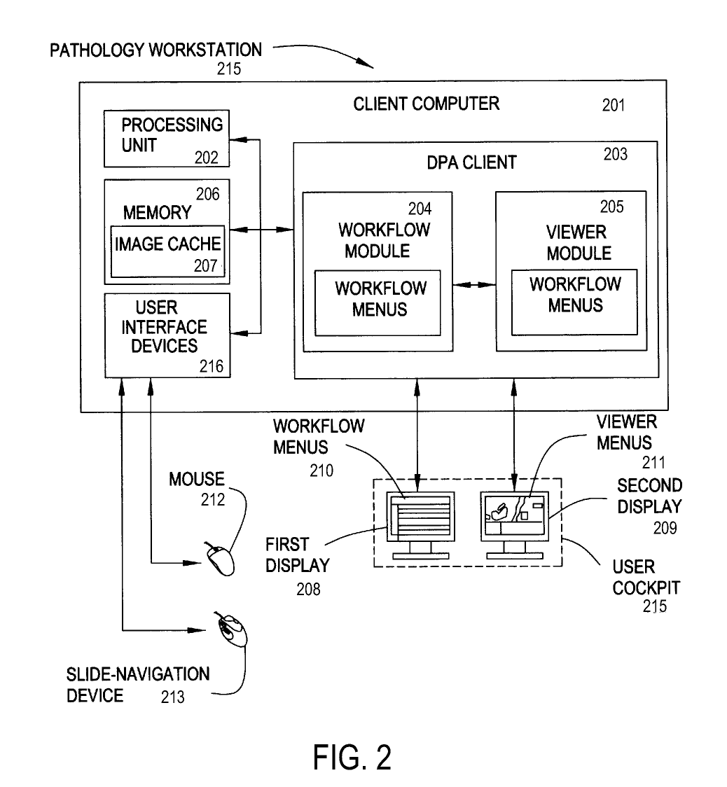

An example pathology workstation configured according to an embodiment is provided in FIG. 2. The workstation 215 is comprised of a computing device 201, such as a desktop PC, laptop, server, or other information handling device, running a digital pathology application (DPA) client 203. The computing device 201 may also include a processing unit 202, local memory 206 for storing, for example, an image cache 207, which may be a local image cache of digital pathology system images for a current session. The processing unit 102 and memory 206 may be used for, inter alia, managing the overall operations of the computing device 201. The processing unit 202 may comprise a standard controller or microprocessor device that is capable of executing program instructions loaded from disk or from the network into program memory, such as instructions from the DPA client 203. The memory 206 may be comprised of any available data storage mechanisms capable of storing digital information that is processed locally or provided by data communications with the computing device 201. User interface devices 216 may be operatively in communication with the processing unit 202, such that input/output devices 212, 213 may function to provide user input to the DPA client 203.

The DPA client 203 may be further comprised of a workflow module 204 and viewer module 205, each providing a set of functions and menus. The workflow module 204 may provide mechanisms for managing workflow such as processing cases, organizing cases, grouping cases, creating folders for sharing cases with others, and the like, for example, through a set of workflow menus 210. The viewer module 205 may be arranged for data presentation that simulates aspects of conventional pathology devices and equipment, such as an optical microscope, in a way that emulates the pathologists' operation of navigation tools and case package management practices that were employed with physical slides and microscopes. For this purpose, the viewer module 205 manages and processes information from a set of viewer menus.

In the example depicted in FIG. 2, multiple displays 208, 209 and multiple input control devices 212, 213 may be utilized to interact with the DPA client 203, digital pathology workstation 215, computing device 201, or some combination thereof. The multiple displays 208, 209 in combination with workflow menus 210 and viewer menus 211, respectively, may operate to create a “user cockpit” 214 system for interacting with the DPA client 203 and the digital pathology workstation 215. In addition, the workstation 215 may be configured such that the first display 208 and mouse input device 212 are dedicated to workflow module 204 operations, and the second display 209 and slide-navigation device 213 are dedicated to viewer module 205 (e.g., image manipulation) operations. For example, the mouse input device 212 and slide navigation device (e.g., trackball) 213 may be arranged in a dual input device configuration. For example, the slide-navigation device 213 may be dedicated to performing “microscope tasks,” such as image navigation, magnification, and focus, essentially emulating a slide-navigation controller. Alternatively, the mouse input device 212 may be used to perform standard point, click, or scroll functions for handling, for example, user interface tasks while operating user cockpit 217. Dual input devices provide pathologists with input devices optimized for each type of task.

Using digital image data relieves the pathologist of tasks associated with handling of slides and manual manipulation of optical instruments. However, there are substantial challenges associated with collecting and presenting image data as comprehensive and detailed as that viewed through a traditional optical microscope. For example, a large number of digital images must be acquired, each encompassing a small area of a specimen at high magnification, in order to provide the level of detail and resolution present in traditional glass slides. In addition, these images must be made available for efficient viewing by a pathologist or other interested parties.

Pathologists typically are experienced with using optical microscopes to view samples. Advantageously, digital images may be presented and manipulated within a digital pathology system in a manner similar to a pathologist's experience with a microscope. In some ways, operating the controls of a computer workstation programmed to display pathology images can be made to resemble operating a microscope. For example, panning with an optical microscope may involve adjusting the position of a stage carrying a sample slide or manually displacing the sample slide on a fixed stage, typically in the direction opposite from the direction of panning. It is possible to embody controls that similarly involve manually displacing a control device to control panning on a displayed digital image. Although it can be advantageous to emulate operation of an optical microscope, some functions that are familiarly undertaken manually with an optical microscope do not have close parallels within a digital environment. In addition, some functions that are very efficient when performed using a digital display do not have corresponding manual functions.

In general, digital pathology systems use robotic and computing devices to obviate manual functions such as adjusting for focus and setting magnification. However, complications often arise when handling image data typically captured as highly magnified small areas of a sample. For example, each image frame is associated with the images of immediately adjacent areas in order to permit panning. Panning can require changing from one captured frame to a next adjacent frame. The image frames may be a patchwork mosaic or collage comprising adjacent or edgewise overlapping tiles or strips. When panning through a boundary between adjacent frames, a continuous transition may be achieved by mathematically merging the image data of the respective frames through an overlapped edge.

In another example, selecting a level of magnification may involve selecting an image captured at a certain magnification or may involve digitally zooming in or out in order to map the captured image pixel data to the pixels of a display. In the latter example, an array of pixel values may be decimated or local pixel values may be averaged to provide a lower resolution version of the same image. Digital zooming is an example of a function improved through the use of digital images. In conventional pathology systems, changes in magnification using optical microscopes typically involved a carousel of lens arrangements that were selectively rotated into position to change the magnification level.

Digital specimen images also facilitate storage of image data and transmission of data over communication networks, which compares favorably with the inconvenience of storing and shipping physical sample slides. In addition, computerized handling enables enhanced sorting and grouping of images with reference to certain information, such as information obtained from patient or specimen databases.

Embodiments provide for accessing, viewing, and manipulating digital images within a digital pathology environment. According to embodiments, multiple images may be viewed simultaneously in various enhanced configurations and further associated in one or more arrangements facilitating comparison of the multiple images, such as the registration of multiple images. Certain embodiments provide for specifying multiple images in one or more lock groups for group application of image manipulation functions, either with or without image registration. Systems configured according to embodiments may stack images in one or more configurations allowing for navigation through the layers of images.

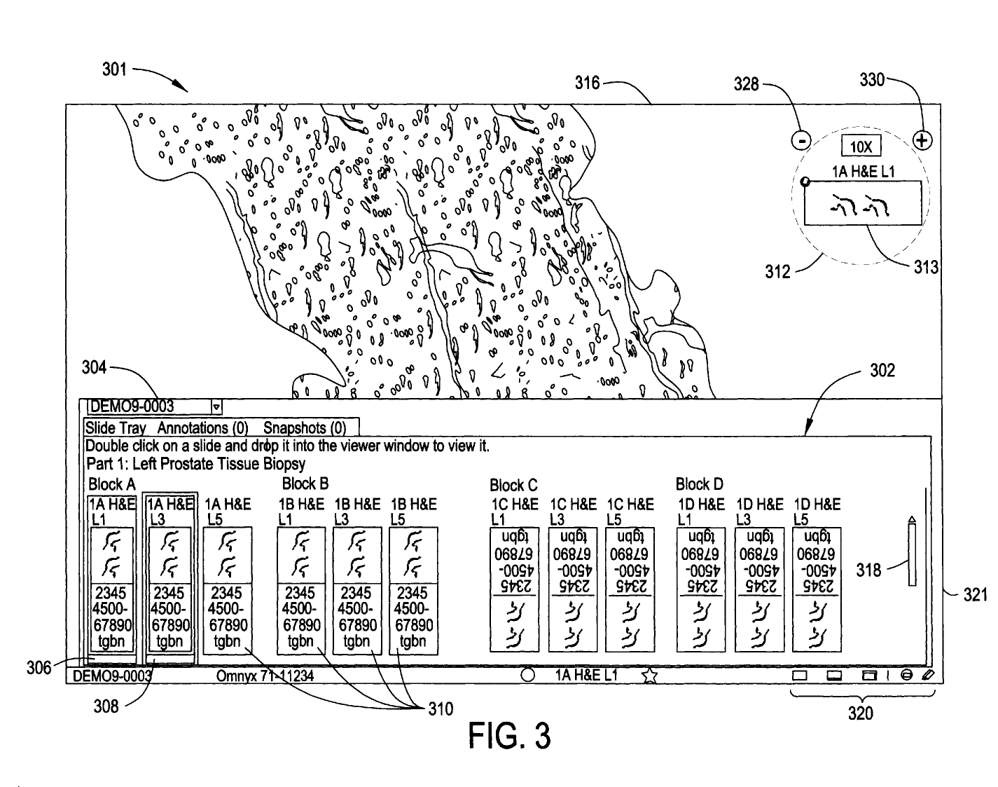

Referring to FIG. 3, therein is provided an example digital image viewer according to an embodiment. Systems configured according to embodiments provide a plurality of tools for image selection for display, including the multiple image viewer of FIG. 3, wherein a combination of images may be displayed. A viewer main menu 301 may provide a menu by which users may view and manipulate slide images. In the example depicted in FIG. 3, a slide tray-level view 302 is active and is configured to provide a familiar visualization to the user, which resembles and/or substantially mimics physical slide trays that are used in physical microscope systems.

The primary components of viewer main menu 301 include, but are not limited to, a microscope viewing window 316 and a slide tray viewing window 302. The microscope viewing window 316 may be configured as a viewing window for displaying images, such as micro-slide images, or portions thereof. The displayed images may correspond to one or more selected slides 306 belonging to a selected case 304, the selected case being displayed in a current case window 304 along with case summary information. In particular, the microscope viewing window 316 may be configured according to embodiments to provide a familiar visualization to a system user, such as a case and slide visualization that resembles and/or substantially mimics the view of slides through a physical microscope.

A microscope stage view 312 may be overlaid atop a portion of the microscope viewing window 316. The microscope stage view 312 may be configured to provide a graphical representation of a physical microscope stage displaying a slide 313 resting thereon and facilitates navigation operations on the displayed slide, for example, through digital zoom controls 328, 330. In the example depicted in FIG. 3, the microscope stage view 312 is illustrated with a graphical representation of a macro-slide image, corresponding to the selected slide 306, resting thereon.

Certain features of viewer main menu 301, such as a tools popup window (not shown), may be toggled on and off by a user. Additionally, the background of certain features of viewer main menu 301, such as microscope stage view 312, may be set to various degrees of transparency through one or more feature transparency or opacity controls (e.g., a slider or drop-down list).

In FIG. 3, the slide tray viewing window 302 is shown overlaid atop a portion of microscope viewing window 316. As a result, microscope viewing window 316 may be configured as the background of other visualizations provided within viewer main menu 301. For the selected case 304, slides 306, 308, 310 are displayed in the slide tray viewing window 302 arranged by block. Other windows and display elements may also be provided in the slide tray viewing window, including, but not limited to, an annotations and snapshots window (not shown).

Selected slides 306 and 308 may be indicated by enlarged icons, or other highlighting methods, while non-selected slides 310 may be indicated through the use of relatively smaller icons or by a lack of highlighting Annotations and snapshots may be added through a annotations and snapshots window (not shown) as soon as they are created. Optionally, when there are no annotations or no snapshots, one or more messages may appear with instructions on how to make an annotation or take a snapshot.

Slide tray viewing window 302, which is shown atop a portion of microscope viewing window 316, may be displayed to various degrees as selected by the user. For example, there may be a fully expanded view, a mini-view, and a fully minimized view of the slide tray viewing window 302. In FIG. 3, the slide tray viewing window 302 is shown in the mini-view state. As such, a limited number of slides 306, 308, 310 are shown, only a portion of the case information is shown in the current case window 304, and a limited number of snapshots are available in an annotations and snapshots window (not shown). In the mini-view of slide tray viewing window 302, a vertical scroll bar 318 may be provided that allows a user to scroll through and view all available information.

When the slide tray viewing window 302 is in the fully expanded view state (not shown), all slides for the current case are shown, all available case information is shown in the current case window 304, and all available snapshots and annotations may be displayed in the annotations and snapshots window (not shown). If there is more than one row of slides, an additional control, such as a horizontal slider bar, may be provided to allow the user to control the size of slides in the slide tray viewing window 302. This functionality allows pathologists to adjust the size of slides according to their own preferences and workstation configuration. When the slide tray viewing window 302 is in the fully minimized view state, no slides are shown, no information is shown in current case window 304, and no snapshots or annotations are displayed in the annotations and snapshots window (not shown).

Because the slide tray viewing window 302 is overlaid atop a portion of the microscope viewing window 316 in the fully expanded view, the least amount of viewing area is made available in the viewer main menu 301. The minimized view results in a relatively larger viewing area in microscope viewing window 316. The mini-view results in an intermediate allocation of space, such that the amount of viewing area in the microscope viewing window 316 is greater in mini-view mode than in the fully expanded view and less than in the minimized view of the slide tray viewing window 302. In addition, one or more icons 320 may be provided on the status bar 321 of the viewer main menu 301. The icons 320 may provide certain functionality, such as an icon indicating the current state of the slide tray viewing window 302, or a control for changing the display of the slide tray viewing window 302.

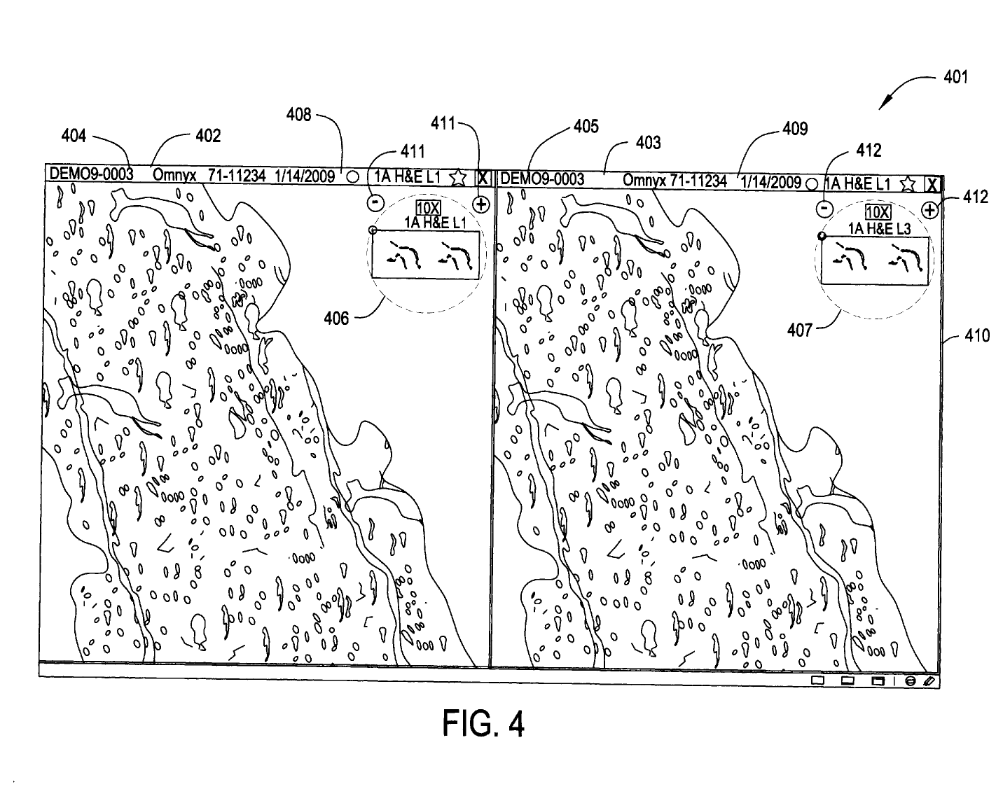

FIG. 4 provides an example of multiple images displayed in a microscope viewing window configured according to an embodiment. The microscope viewing window 401 may be split into multiple windows, each comprising its own set of controls. In the example depicted in FIG. 4, the microscope viewing window 401 is split into two windows 402, 403. Each window 402, 403 has its own set of viewing controls 411, 412 and elements, including patient and slide information 404, 405 and microscope stage views 406, 407. Embodiments provide for differential display features based on certain digital image characteristics, such as whether the images are from the same case. In the example of FIG. 4, the digital images are from different cases, as such, each case is differentiated through the display of unique header bars 408, 409 for each case (e.g., differentiated through color, pattern, etc.). In addition, the active digital image may be designated through an active image border 410.

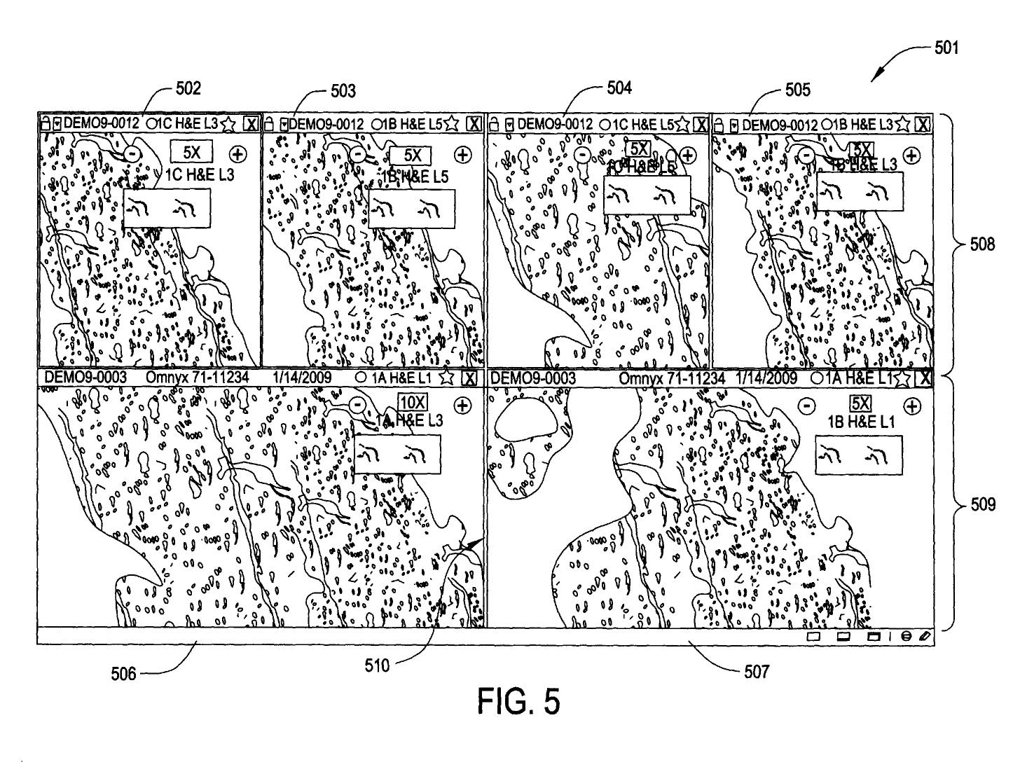

In FIG. 5, therein is provided another example of multiple images displayed in a microscope viewing window configured according to an embodiment. The microscope viewing window 501 is divided into six sections 502-507 for displaying six distinct images. According to embodiments, the six images may be selected from a single case, anywhere from two to six different cases, more than six cases, or a combination thereof. The top half 508 of the microscope viewing window 501 is divided into four different sections 502-505 for viewing four images, and the bottom half 509 of the microscope viewing window 501 is divided into two different sections 506, 507 for viewing two images. Embodiments provide that the configuration of images presented in the example of FIG. 5 is not static. For example, the arrangement of sections 502-507 may be modified, such as being resized or repositioned to another area within the microscope viewing window 501. Splitter bars 510 are available between each pair of adjacent images. The user may grab (click) and drag the splitter bars 510 to resize one or more of the images 502-507 in the microscope viewing window 501. In addition, the user may select one of the images 502-507 and reposition it within the microscope viewing window 501.

Slide images, such as thumbnail images (e.g., selected slides 306, 308 of FIG. 3), may be selected and dragged onto a portion of the microscope viewing window 501. Embodiments provide that the system may apply default rules to divide the area of the microscope viewing window 501 to accommodate the newly added images. A non-limiting example provides that a display region displaying a first image in a single window may be divided in half to form two equally sized regions responsive to the opening of a second image within the display region. Another illustrative and non-restrictive example involves a display region displaying first and second images in equally divided windows, wherein a third image is directed to be opened in the first image display window (e.g., by dragging an image icon and dropping it onto the first image display window). In this example, the first image display window is divided in two, displaying the first and third images in equally divided sub-windows, while the second image is displayed in the original second display window. However, additional embodiments provide that if image display windows are separately displaying first and second images, directing a third image to be opened in either window will lead to a configuration wherein the first, second, and third images are displayed within equally sized windows (i.e., each comprising ⅓ of the available viewing area). Differences in the display of images may be related to certain system configurations, such as default configurations, user preferences, or situational configurations (e.g., whether the images are from the same case). A non-limiting example provides that a user may have a preference wherein the windows are always equally sized. Another illustrative and non-restrictive example provides that windows are sized based on case, such that each newly opened slide will only cause resizing of windows displaying slides belonging to the same case.

Any given case has “N” number of available slides, a certain maximum number of which may be selected from the slide tray and positioned onto a desired screen location. Embodiments provide for any suitable maximum number of slides, such as only allowing a maximum of six slides to be opened at any given time. When a user selects a slide and drags it to the viewable window, embodiments provide that a placement indicator may be displayed indicating, for example, that placing the images to the left, right, bottom, or top location on the window will split the image(s) in respectively different ways, based on the location where the new slide was dropped on the microscope viewing window. Once the slide is dropped in place and the microscope viewing window is split according to the default rules, the user can resize any or all of the images currently being displayed as desired, for example, using available splitter bars.

In addition to displaying distinct images, systems configured according to embodiments may display multiple copies of the same image within the microscope viewing window. Similar to the process for displaying multiple distinct images explained above, once the user displays a slide on one of the window sections (depending on the number of open images), the user can then select that same slide and drag it to either the left, top, bottom, or right of the viewable window. This action will split the microscope viewing window accordingly, for example, displaying two windows each displaying a copy of the image.

Embodiments provide for the display of multiple cases associated with a single patient. For example, the same patient may have had two or three distinct sets of images collected at respectively different times, such as before and after starting treatment for a particular medical condition. An image viewer configured according to embodiments may allow any combination of up to a certain limit (e.g., six) of images (including multiple instances of a single image) from current and prior cases associated with a single patient to be displayed in any desired configuration within the viewer. The user may additionally select a different slide tray to view slides from the current case or a prior case for the same patient. This allows a user to see an image from one case next to an image from another case for the same patient.

In addition to comparing specimens collected from the same patient, embodiments are configured to display images from other patients and control slides, for example, for comparative or instructive purposes. For example, a slide indicative of a certain tissue/stain type may be opened in an image viewer which can be used as a reference to diagnose the slide currently being viewed. As such, embodiments are configured to allow for side-by-side viewing of images from multiple sources, including, but not limited to, one or more cases for a patient, cases from additional patients, reference slides, control slides, and teaching slides.

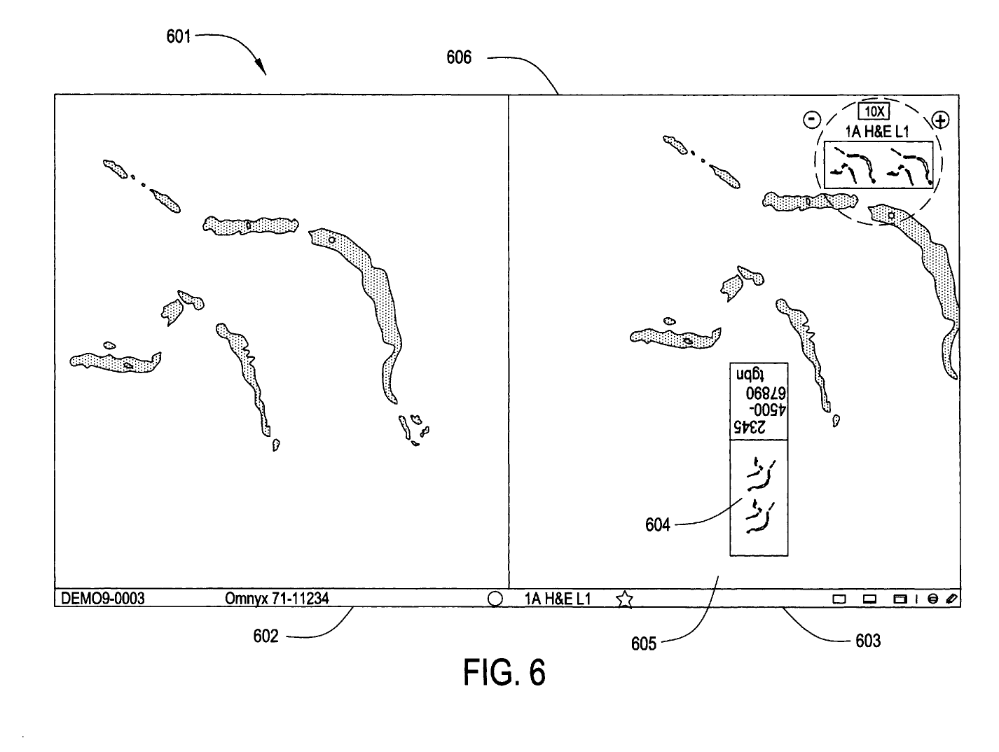

FIG. 6 provides an example of image placement according to an embodiment. The microscope viewing window 601 provides the user with the ability to select an image display location aided through the use of one or more placement indicators for ensuring proper placement. For example, as a user drags a thumbnail image 604 of a slide onto the viewer canvas 605, a placement indicator appears indicating where the image will open if the thumbnail image 604 is dropped at its current location. In the example of FIG. 6, the placement indicator is comprised of highlighting 606 the region where the image will display with a border; however, embodiments provide for any type of placement indicator capable of achieving similar results, including, but not limited to, shading, coloring, highlighting, or enclosing the area where the slide will display.

Embodiments provide that if the user drags a thumbnail image 604 to the center of an open image, the new image may replace the image previously displayed in that location. According to embodiments, if the user drags the thumbnail image 604 to the right, left, top, or bottom of an existing image, the placement indicator 606 moves with the thumbnail image 606, and the existing image will shift accordingly to split the available space (e.g., 50/50) with the newly added image. As such, a user can place images in any configuration. Illustrative and non-restrictive examples of configurations include, but are not limited to, two images on the top plus four on the bottom, three images on top plus three on bottom, six images in a single vertical row, and six images in a single horizontal row.

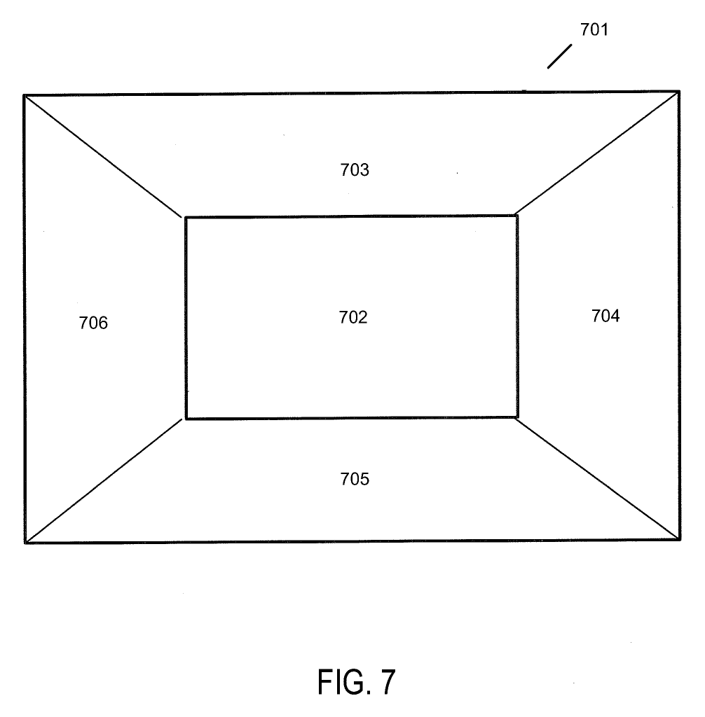

Referring to FIG. 7, therein is provided an example grid used for image replacement or screen splitting according to an embodiment. Each microscope viewing window 701 may be divided into zones according to embodiments; the example of FIG. 7 is divided into five zones 702-706. According to embodiments, the zones may be configured to represent top, bottom, left, right, and center zones of an image, window, or other display element. The zones may be preconfigured and are not visible during use of a microscope viewing window.

The following provide illustrative and non-restrictive examples of image placement within viewing window zones 702-706: (a) if a new slide is dragged and dropped into zone 702, then the new slide image replaces the image currently displayed in viewing window 701; (b) dragging and dropping a new slide into zone 706 or 704 results in the viewing window 701 being split left-to-right by launching a new viewer window instantiation; (c) if the slide is dropped into zone 706, the existing viewing window 701 is resized to occupy the right half of the viewing window 701, and the newly launched window is sized and positioned in the left half of viewing window 701; (d) if the slide is dropped into zone 704, the existing viewing window 701 is resized to occupy the left half of viewing window 701, and the newly launched window is sized and positioned in the right half of viewing window 701; (e) if the new slide is dragged and dropped into zone 703 or 705, the viewing window is split top-to-bottom by launching a new viewer window instantiation; (f) if the slide is dropped into zone 703, the existing viewing window 701 is resized to occupy the bottom half of viewing window 701, and the newly launched window is sized and positioned in the top half of viewing window 701; (g) if the slide is dropped into zone 705, the existing viewing window 701 is resized to occupy the top half of window 701, and the newly launched window is sized and positioned in the bottom half of viewing window 701.

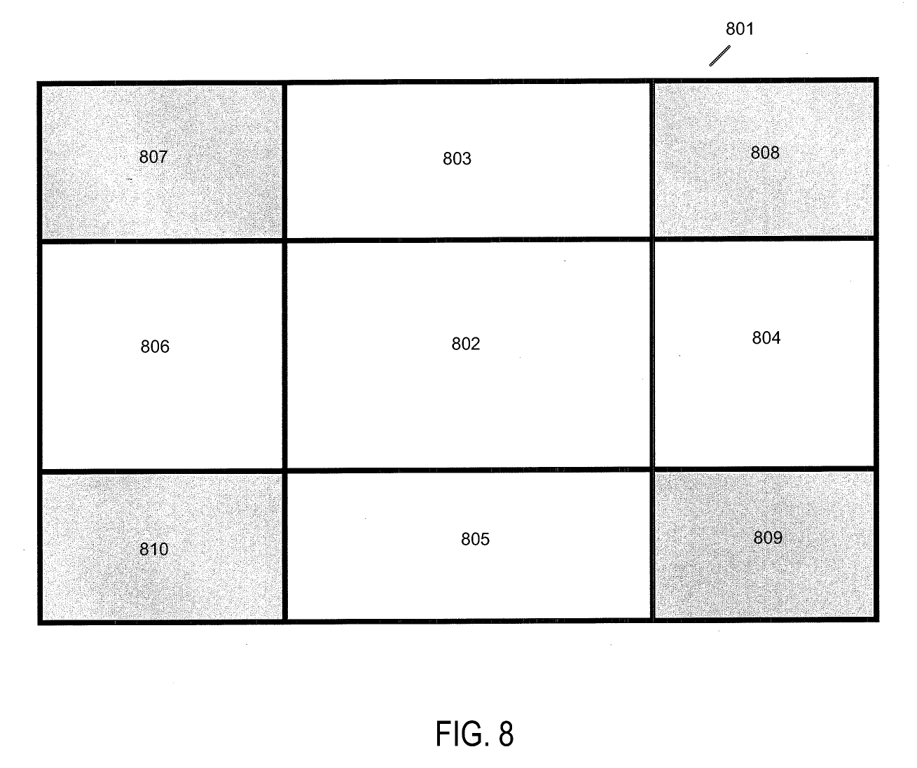

FIG. 8 depicts another example grid used for image replacement or screen splitting according to an embodiment. The grid 801 is a variation of the grid depicted in FIG. 7 with corresponding zones such that zone 702 of FIG. 7 corresponds to zone 802 of FIG. 8, zone 703 with zone 803, and so on. The zones 802-806 are laid out in a regular grid of rectangles as shown in FIG. 8. When a pointer object, such as a cursor or the slide icon, is over one of the zones 802-806, a placement indicator (e.g., as described in FIG. 6) configured according to embodiments may be displayed. The shaded areas 807-810 do not allow for image placement or screen splitting, for example, because an image in that area is locked or a display element (e.g., microscope staging area) is located in that zone, so a placement indicator is not displayed when a pointer object is located therein.

Once a microscope viewer window configured according to embodiments has been split, each of the split windows has a respective hidden grid such as the grids depicted in FIGS. 7 and 8, allowing further image replacement or window splitting, as described above. When a user drops a thumbnail image into any location to the left, right, top, or bottom of one or more existing image(s), the existing images are resized according to embodiments so as to evenly distribute the image sizes after the dropping.

An illustrative and non-limiting example of handling image display is hereby described in reference to the example depicted in FIG. 6. If the microscope viewing window 601 were displaying only one image, for example, the image being displayed in window 602, then when a second image is dropped on the right side of the first image in the microscope viewing window 601, the window may be split in half, with the first image in window 602 and the second image in window 603. As the thumbnail image 604 is moved into the right side of the viewing window 601, the placement indicator 606 appears, for example, in the form of a border, at the location where the new image associated with the thumbnail 604 will be displayed. While the thumbnail 604 is moving, the placement indicator 606 remains in one position, until either (1) the thumbnail is dropped, to open the image in that position; or (2) the thumbnail is moved into another section (e.g., left, right, top, or bottom half) of the previously displayed image, which changes the portion of the viewing window 601 appearing as shaded. For example, if thumbnail 604 is moved to the top, then the highlighted region 606 moves to the top half of the viewing window 601. In another example, if the thumbnail 604 is moved into the center of the viewing window 601, the entire window 601 may become highlighted (e.g., shaded, colored, surrounded by a border) to notify the user that the currently displayed image will be closed responsive to placing the thumbnail image 604 at that location.

According to embodiments, after the user has split the windows, the user can grab (click and hold) the splitter controls for a window and drag it to either enlarge the image or to reduce the image width and height. Embodiments additionally provide for automatically resizing one or more images in the microscope viewing window based on how the user resizes the window. A non-limiting example provides that if a user closes a window, any remaining images may be automatically resized to take advantage of the newly available display area.

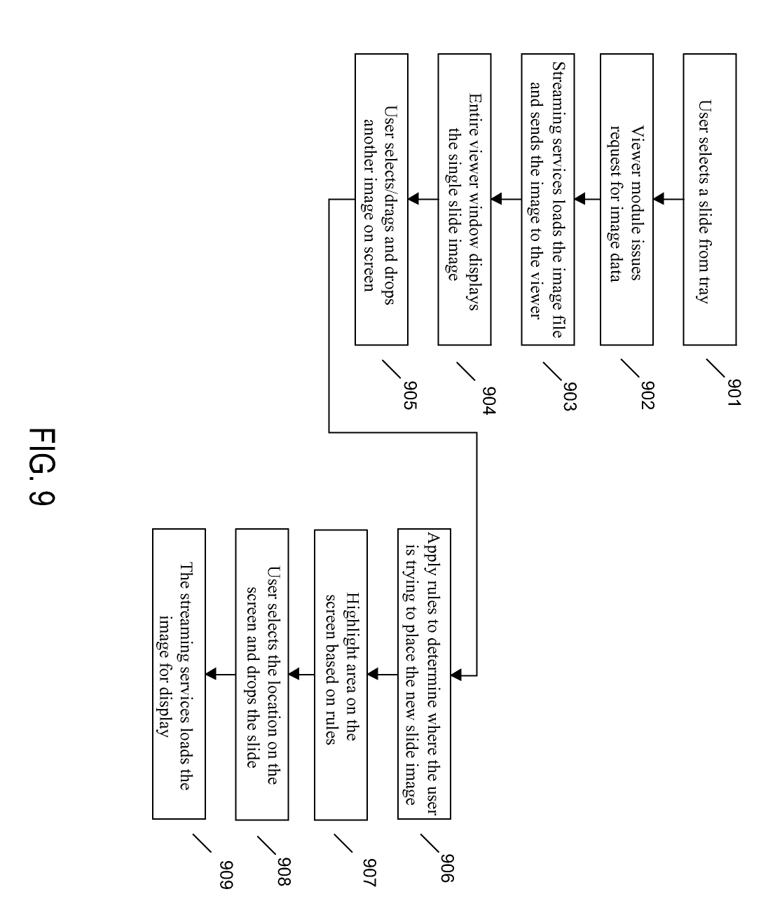

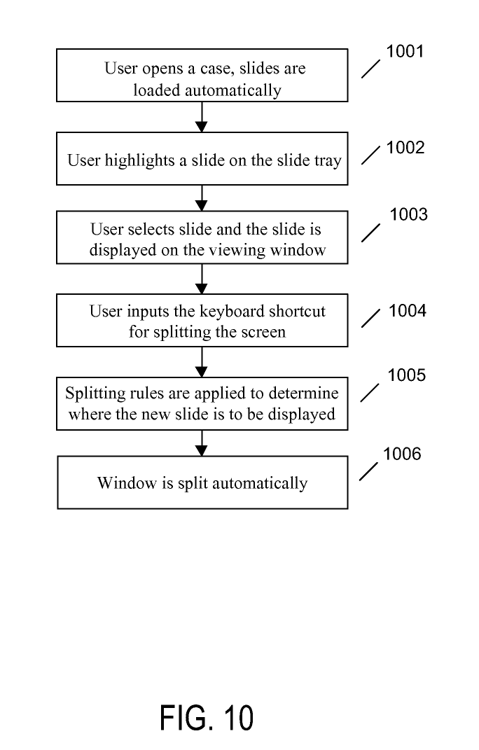

FIGS. 9 and 10 provide example processes for image selection using a pointing device and a keyboard, respectively, according to embodiments. These methods are not mutually exclusive as systems configured according to embodiments may allow a user to use either method interchangeably. For example, a first image may be opened using a pointing device and a second image may be opened using keyboard.

FIG. 9 provides an example process for image selection using a pointing device (i.e., mouse or trackball pointing device) according to an embodiment. The user selects a thumbnail image from a set of available images 901, such as from the slide tray 302 of FIG. 3, using the pointing device and drops the thumbnail image into the microscope viewing window. The viewer module issues a request for the image data 902, for example, to a diagnostic archive server. Streaming services retrieves the image file from the image database and sends the image to the pathology workstation 903.

The microscope viewing window displays the first image using the entire microscope viewing window 904. A user selects additional thumbnail images from the slide tray using the pointing device, and drags the thumbnail image(s) onto the microscope viewing window 905. The system applies rules configured according to embodiments to determine where the user is trying to place the new slide image(s) 906. For example, the system may first determine the location of the thumbnail(s) relative to the image over which the thumbnail(s) is positioned. According to embodiments, the window in which the current image is displayed may be divided into the following five zones: center, left, right, top and bottom, as described above in FIGS. 7 and 8. If the pointing device cursor thumbnail image(s) is in the center, the existing image may be closed and replaced by the new image. If the pointing device cursor or thumbnail image(s) is in the left, right, top, or bottom zone, the existing image window may be split into two or more zones and resized to display the additional images.

A placement indicator is provided to indicate the potential location of the image when displayed 907, including how the microscope viewing window may be split and where the new image may be placed. If the pointing device cursor or thumbnail image(s) are in the left or right zone, the existing window where the image(s) will be displayed is divided into left and right windows. Similarly, if pointing device cursor or thumbnail image(s) are in the top or bottom zone, the existing window where the image(s) will be displayed is divided into top and bottom windows. The placement indicator may be configured to indicate how the window will be split responsive to image(s) placement. Embodiments provide that if N (where N>1) new slides have been selected for display, then the existing image window may be evenly divided into N+1 equally sized windows, with N windows for the new images plus an additional window for the existing image.

The user may select a screen location, highlighted according to embodiments, and drop the thumbnail image(s) at the chosen location 908. The viewer module displays the image data loaded from streaming services 909. Steps 901-909 may be repeated up to the limit of allowable slides, thereafter the user can replace any of the existing images by dragging and dropping a new image thumbnail into the center zone of the image that is to be replaced on the display.

Referring to FIG. 10, therein is provided an example process for image selection using a keyboard (i.e., keyboard shortcuts) according to an embodiment. A user opens a case, for example, by using a shortcut key or by using the “tab” key to move the cursor to the drop-down list (e.g., current case window 304 of FIG. 3) for case selection 1001. Once the drop-down list is accessed, the up and down keyboard arrows may be used to scroll through the case list, and case selection may be made, for example, by using the “enter” key. The user selects or highlights an available slide, for example, accessible through the slide tray viewer 1002. According to embodiments, the user uses a first shortcut key to move the cursor to the slide tray and another key (e.g., the tab key) to move the selection (highlight) among the available images. Once the desired slide thumbnail is highlighted, the user makes the selection by pressing the enter key, or another shortcut key and the first image is displayed on the microscope viewing window 1003.

The user may input a keyboard shortcut for splitting the screen 1004. According to embodiments, the screen may be split according to one or more predetermined rules, which selects the screen configuration for any given number of open images. Non-limiting examples of predetermined rules include equally dividing the screen for each image, or dividing the screen per case and then per each image within the case. Additional non-limiting examples provide for default rules wherein the viewing window may be divided evenly for up to four images, and thereafter maintain two quarter-screen images plus three one-sixth (⅙) or four one-eighth (⅛) images. Another default rule may divide the digital image viewer window evenly up to the limit of displayed images.

Splitting rules configured according to embodiments are applied to determine where the image(s) are to be displayed 1005. In addition, embodiments provide for certain user preferences, or menu or dialog boxes which allow a user to select from two or more available default screen splitting options. For example, if multiple image windows are open, the screen splitting step 1005 may permit the user to select which window is to be split to accommodate a new image. A non-limiting example provides that if there are already two half-screen windows open, the user can select one of the two half-screens to be further split into two quarter-screens. The window is split automatically 1006 and the image is displayed. Steps 1002-1006 may be repeated for additional slides up to a display limit.

The viewer module may be configured according to embodiments to provide additional capabilities for automatic image size, shape, or location adjustments. For example, if the viewing window has already been split and currently displays multiple images, the user may close one of the images, for example, through an image close control. Embodiments provide that closing an image window automatically adjusts the size and location of some or all remaining image windows to fill the vacated space, according to one or more default configuration rules. A default configuration rule according to embodiments provides that the remaining open windows may be reconfigured to have the same size if there are up to four images open after closing a window (e.g., ½ for two images, ⅓ for three images, and ¼ for four images), and that the remaining open windows are all reconfigured to ⅙ of the screen if there are five images open after closing one window.

A digital pathology system user may need to maximize a particular image displayed along with other open images. Embodiments provide that each image window may have a maximize image control for temporarily maximizing the image size to occupy the entire digital image viewer window. Selecting the maximize image control on an image window automatically resizes the selected image to full screen and temporarily minimizes all other open image windows. Certain embodiments provide that the user can restore the screen to multi-image view by selecting a restore multi-view control that appears or is activated when an image window is maximized. In certain embodiments, the user can restore the screen to multi-image view by pressing a key on the keyboard, such as the “escape” key. Each image window may have a minimize image control for minimizing an image window without closing it. Embodiments provide that minimizing one of the open image windows automatically temporarily resizes all the remaining windows as though the minimized window were closed.

A digital pathology workstation may be configured according to embodiments to support multiple monitors. For example, embodiments may provide for a user cockpit which includes multiple viewer displays such that the viewer module may place multiple images across multiple monitors in any desired configuration. Depending on the number of monitors, the monitors may be connected to the workstation computer or to a display server via a network. For example, to support more than two monitors in the system, the workstation computer may be equipped with an extra video card that can support additional monitors. In such an embodiment, the digital microscope view window may be configured to include icons representing respective monitors. Rather than dragging and dropping a slide into a portion of the microscope view window to make a selection, embodiments provide that the user may drop the slide onto one of the monitors. For example, in a configuration including four monitors, the user can select and drag four images from the slide tray and place each image on a separate monitor rather than splitting the images on one monitor.

According to embodiments, images may be rotated using a pointing device (e.g., trackball) or visual element (e.g., microscope stage view) in order to align the images for comparison. For example, a user may scroll the wheel on a mouse or the ball of a trackball, or click a “rotate” icon on a microscope stage viewer. The viewer module may then rotate the image according to the sensed displacement or query the user for a rotation angle to rotate the image. Embodiments further provide for the capability to zoom in and out of magnification levels in order to see any desired amount of image detail. For example, the user can select “zoom” by a pull-down or pop-up menu or may make a zoom selection and displace the scroll wheel of a mouse or the ball of a trackball device. The viewer module then zooms in or out according to the sensed displacement or based on the value received from a zoom query response.

A viewer module configured according to embodiments may provide the ability to move or pan on one image to align that image as close as possible to another image. In order to perform this alignment automatically, embodiments provide that the system may attempt to minimize a difference array containing the difference between the values (e.g., luminance or one of the R, G, and B components) of two corresponding locations in each image, as a function of the translation or offset. Using a numerical method (e.g., half-interval method), the difference array having the smallest value after any number of iterations may be selected, or the system may continue iterating until one or more convergence criteria are reached. Embodiments provide that the difference array calculations may be performed over a relatively small area near the center of one image, and this region can be compared to the same sized region in the second image with various offsets.

Multiple images may be co-registered according to embodiments, wherein two or more selected images may be automatically oriented for simultaneous viewing according to an expressly specified or automatically matched location on a reference image. This capability may be useful, for example, when viewing plural parallel slices of the same mass of tissue, to facilitate recognition of variations between slices, such as variations over time or in response to treatment.

Co-registration according to embodiments involves opening two or more slides, for example, in a side-by-side configuration and initiating a function to automatically register the images. The co-registration process automatically determines the scaling, translation, and rotation matrices for registering the images as closely as possible to the reference image. Embodiments provide that rotation registration is performed based on the center of the reference image. After completion of co-registration, the matching features of the images are aligned as closely as possible. To the extent that a non-uniform transformation is applied to one of the images (e.g., due to a deformation of a part of the specimen in one of the images), the co-registration algorithm selects a co-registration operation that minimizes the differences between the aligned images (e.g., a least squares fit).

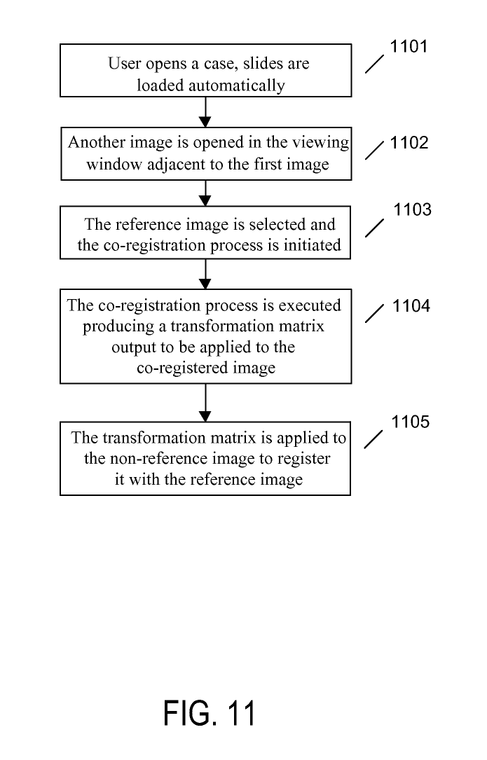

In FIG. 11, therein is provided an example process for image co-registration according to an embodiment. A user selects a first image for display on the viewing window 1101, for example, by selecting a slide from the slide tray viewer. Another image is opened in the viewing window 1102 adjacent to the first image, such as in a side-by-side configuration. The user selects the reference image and initiates the co-registration process 1103. The system automatically executes the co-registration process, which outputs the transformation matrix to be applied to the co-registered image 1104, which may include translation, rotation, scaling, or some combination thereof. Embodiments provide that the transformation matrix comprises image characteristics of the reference image to be applied to the co-registered image. Non-limiting examples of image characteristics include orientation, magnification level, brightness, contrast, position, and scale. The calculated transformation matrix is applied to the non-reference (second) image to register it with the reference image 1105. The two images may then be viewed side by side with substantially the same position, scale, and orientation, so that differences between the actual specimen(s) imaged in the two images are more easily recognized.

Multiple images may be designated as belonging to one or more Lock Groups configured according to embodiments. A non-limiting example provides that images may be selected, such as from a slide tray viewer, and designated as being “locked.” According to embodiments, after the images are opened in their respective windows, a lock function may be selected, and the images may be positioned in one of the locked window and the reference window. Once the user selects multiple images and sets them as “locked,” any image manipulation function, such as pan, zoom, and rotation functions, applied to any of the locked images is automatically applied to the other images. Once the images have been locked, embodiments provide that any automatic rotation may be applied based on the center of each image. Certain embodiments may be configured to provide multiple unique groups of locked images.

In the images that are not at the same magnification prior to locking the images, embodiments provide that the system may automatically adjust image display characteristics, such as pan or zoom, to take magnification differences into account. For example, if a first image is at 1× magnification and a second image is at 20× magnification, embodiments provide that panning the first image 1 mm will pan the second image by 20 mm (20 times the offset of image 1), and vice versa.

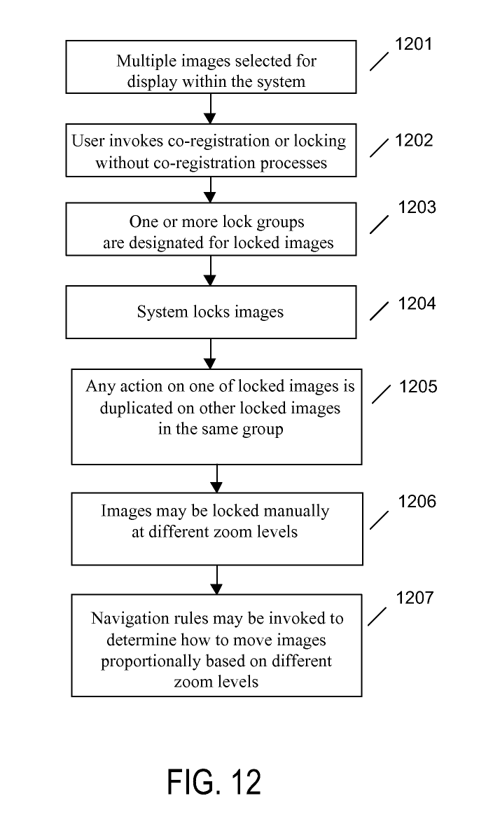

FIG. 12 provides an example process for locking images according to an embodiment. A user selects multiple images for display within the system 1201 and invokes either a co-registration process (see FIG. 11) or a locking process without co-registration on the images 1202. If the co-registration process is selected, embodiments provide that the system scales the non-reference image to the same size as the referenced image and aligns the two images (see FIG. 12). Alternatively, if locking without co-registration (i.e., “locking”) is selected, the images are designated as locked images. For example, locked images may be viewed at different magnifications, as such, locking may be performed manually to preserve original scaling.

The user may designate the locked images as being an independent group of locked images (e.g., Locked Group 1, Locked Group 2, etc.) 1203. For example, images in a first locked group will be locked to each other and not to other groups, while images in a second locked group will be locked to each other and not to the first locked group. The system locks the images 1204 and after the images have been locked, any action (e.g., panning, rotation, or zoom) performed on any one of the locked images will automatically be performed on the other locked images in the same group 1205. The locked images may be manually locked at different zoom levels 1206. Navigation rules configured according to embodiments may be invoked in the case of images having different magnifications 1207, or zoom levels, wherein the navigation rules determine how to scale operations performed on one image to other images in the group.

Embodiments provide for applying additional processes across multiple images. For example, a system configured according to embodiments may allow a user to select a region of interest (ROI) on a first slide, perform processing operations on the slide, and then select one or more subsequent slides in which the application should automatically find that same ROI and apply the same processing operations. This technique may be used to apply a common adjustment to plural images. According to embodiments, if the user locks two or more images, then any processing operations applied to one of the locked images is also applied to the rest of the images in that locked group, unless specified otherwise. A non-limiting example provides for image sharpening processes to be applied across designated images, such that a common sharpening process may be simultaneously applied across multiple images. Illustrative and non-restrictive examples of processing operations include brightness, contrast, and RGB value adjustment functions.

Automatic orientation and image placement of images according to predetermined protocols may be configured according to embodiments. A non-limiting example provides that the system may determine based on the tissue type, stains ordered, and type of procedure preformed, which slides should be automatically populated in the viewer and in which order they should appear responsive to opening a case. According to embodiments, one or more predetermined protocols may be defined and associated with images entered into an image database. Embodiments provide that if a user selects any of the images associated with one of the protocols, and then chooses a protocol (e.g., from a pull-down or popup menu), the viewer module automatically opens the other images defined by that protocol, located and orientated based on the predetermined protocol.

Multiple viewing characteristics are associated with displaying images and cases, such as orientation and magnification. In addition, certain users may have certain preferences for viewing cases, such as specific image placement and magnification characteristics, as well as the number and position of windows displayed on the screen. Embodiments provide for persistent viewing states, for example, when a user switches context. A non-limiting example of a persistent viewing state provides that the magnification, rotation, and image placements are maintained as long as the case is open. As previously described above, a pathologist selects a case from a case list and is provided access to case images available for display. If a user is accessing a first case and subsequently selects a second case (either a previously opened case or newly opened case via the case list) without closing the first case, the first case remains “open” in the viewer module system. The user can explicitly close a case, for example by clicking a “Close Case” control, a “Review Complete” control, or by logging out of the system. Embodiments provide that as long as a case is still open, anytime the user returns to the tab for an earlier viewed case, the magnification, rotation, and placement of images will be exactly as the user left it.

Multiple images may be overlaid over other images to generate image overlays according to embodiments. Different presentation methods may be utilized to navigate through the image overlays, for example, in a predetermined order. Non-limiting examples of presentation methods include “flip-book,” “slide show,” or “film strip” methods in which a user could flip, page, or scan through the images, for example, to see how the morphology changes over time. Certain embodiments provide that the system may allow the user to adjust the opacity of each individual image for viewing the layers superimposed on each other. An annotation may be placed on one image and duplicated across other images in the same tissue location for overlaid images configured according to embodiments. In one embodiment, if a user executes an automatic co-registration process (e.g., the process provided in FIG. 12), the duplication of annotations may be performed after the co-registration, so that the annotation does not appear translated, rotated or scaled in the non-reference image.

Multiple users may seek to access and manipulate images within a digital pathology environment. For example, a first pathologist may want to consult with a second pathologist in another location regarding a particular case or one or more digital specimen images. In addition, educational opportunities exist where multiple remote users may access a common set of cases or images. Embodiments provide that multiple users may remotely view and manipulate images, for example, within a singe viewer session. According to embodiments, a “Consult Mode” is configured to connect multiple remote users to the same session. A non-limiting example provides that a notification is sent by the requesting pathologist to the receiving pathologist. The receiving pathologist accepts or rejects the connection. Once connected, users can transfer control between each other and each can view (in real time) what the other is doing, such as accessing, manipulating, or designating one or more images.

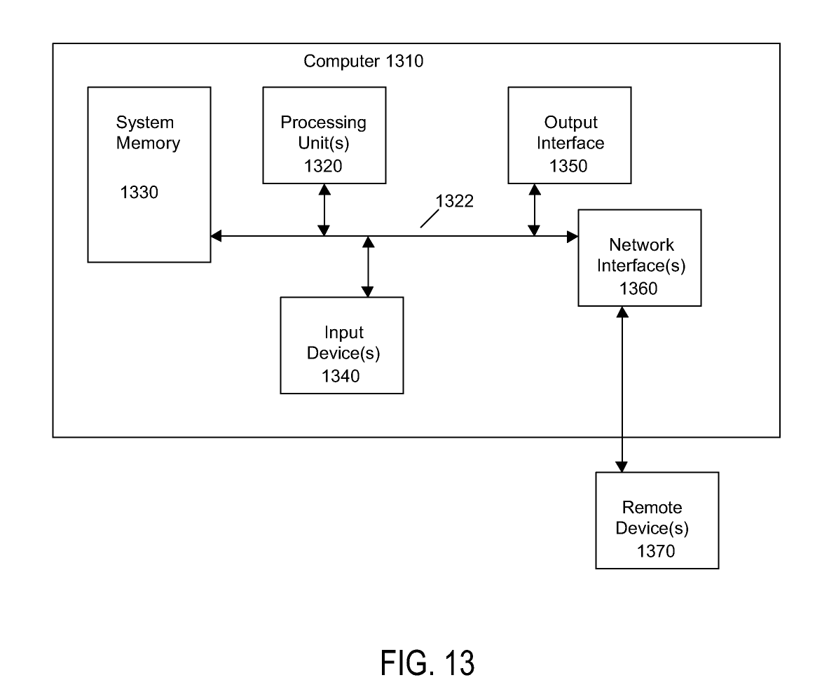

Referring to FIG. 13, it will be readily understood that certain embodiments can be implemented using any of a wide variety of devices or combinations of devices. An example device that may be used in implementing one or more embodiments includes a computing device in the form of a computer 1310.

Components of computer 1310 may include, but are not limited to, a processing unit 1320, a system memory 1330, and a system bus 1322 that couples various system components including the system memory 1330 to the processing unit 1320. The computer 1310 may include or have access to a variety of computer readable media. The system memory 1330 may include computer readable storage media in the form of volatile and/or nonvolatile memory such as read only memory (ROM) and/or random access memory (RAM). By way of example, and not limitation, system memory 1330 may also include an operating system, application programs, other program modules, and program data.

A user can interface with (for example, enter commands and information) the computer 1310 through input devices 1340. A monitor or other type of device can also be connected to the system bus 1322 via an interface, such as an output interface 1350. In addition to a monitor, computers may also include other peripheral output devices. The computer 1310 may operate in a networked or distributed environment using logical connections to one or more other remote computers or databases. The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
one or more processors;
a memory in operative connection with the one or more processors;
wherein, responsive to execution of program instructions accessible to the one or more processors, the one or more processors are configured to:
display one or more digital specimen images in one or more viewing windows arranged in one or more viewing configurations; and
associate one or more images through one or more correlation processes comprising image co-registration, image locking, and image overlay processes.

2. The system according to claim 1, wherein the one or more viewing windows comprise one or more microscope viewing windows and one or more slide tray viewing windows.

3. The system according to claim 1, wherein each of the one or more viewing windows comprise an image grid for handling image replacement or screen splitting responsive to selecting a digital specimen image for display in a viewing window.

4. The system according to claim 3, wherein the image grid is divided into a plurality of zones comprising center, top, bottom, left, and right zones.

5. The system according to claim 1, wherein the co-registration process comprises:
receiving a reference image and non-reference image selection;
generating a transformation matrix comprising image characteristics obtained from the reference image, the image characteristics comprising scaling, translation, and rotation characteristics; and
applying the transformation matrix to the non-reference image.

6. The system according to claim 5, wherein the rotation characteristic is based on the center of the reference image.

7. The system according to claim 1, wherein the image locking process comprises:
receiving a plurality of image lock selections configured in one or more lock groups;
applying image manipulation functions designated for one of the plurality of image lock selections to remaining images in the plurality of image lock selections.

8. The system according to claim 7, wherein the image manipulation functions comprise pan, magnification level, and rotation functions.

9. The system according to claim 1, wherein the image overlay process comprises arranging a plurality of image overlay selected images in an image overlay presentation configuration, the image overlay presentation configuration comprising flip book and slide show configurations.

10. The system according to claim 9, wherein the image overlay process further comprises modifying an opacity value for images in the image overlay presentation configuration.

11. A method comprising:
displaying one or more digital specimen images on a display device in one or more viewing windows arranged in one or more viewing configurations; and
associating one or more images through one or more correlation processes comprising image co-registration, image locking, and image overlay processes.

12. The method according to claim 11, wherein the one or more viewing windows comprise one or more microscope viewing windows and one or more slide tray viewing windows.

13. The method according to claim 11, wherein each of the one or more viewing windows comprise an image grid for handling image replacement or screen splitting responsive to selecting a digital specimen image for display in a viewing window.

14. The method according to claim 13, wherein the image grid is divided into a plurality of zones comprising center, top, bottom, left, and right zones.

15. The method according to claim 11, wherein the co-registration process comprises:
receiving a reference image and non-reference image selection;
generating a transformation matrix comprising image characteristics obtained from the reference image, the image characteristics comprising scaling, translation, and rotation characteristics; and
applying the transformation matrix to the non-reference image.

16. The method according to claim 15, wherein the rotation characteristic is based on the center of the reference image.

17. The method according to claim 11, wherein the image locking process comprises:
receiving a plurality of image lock selections configured in one or more lock groups;
applying image manipulation functions designated for one of the plurality of image lock selections to remaining images in the plurality of image lock selections.

18. The method according to claim 17, wherein the image manipulation functions comprise pan, magnification level, and rotation functions.

19. The method according to claim 11, wherein the image overlay process comprises arranging a plurality of image overlay selected images in an image overlay presentation configuration, the image overlay presentation configuration comprising flip book and slide show configurations.

20. A computer program product comprising:
a computer readable storage medium having computer readable program code embodied therewith, the computer readable program code comprising:
computer readable program code configured to display one or more digital specimen images on a display device in one or more viewing windows arranged in one or more viewing configurations; and
computer readable program code configured to associate one or more images through one or more correlation processes comprising image co-registration, image locking, and image overlay processes.
